(19) United States
(12) Patent Application Publication
(10) Pub. No.: US 2026/0037325 A1
(43) Pub. Date: Feb. 5, 2026

(54) Architecture Framework for Ubiquitous Computing

(71) Applicant: Apple Inc., Cupertino, CA (US)

(72) Inventors: Sudeep MANITHARA VAMANAN, Uttenreuth (DE); Haijing HU, Los Gatos, CA (US); Mona AGNEL, Guildford (GB)

(21) Appl. No.: 18/996,417

(22) PCT Filed: Jul. 25, 2023
(86) PCT No.: PCT/US2023/028561

§ 371 Date: Jan. 17, 2025

Related U.S. Application Data
(60) Provisional application No. 63/369,415, filed on Jul. 26, 2022.

(51) Int. Cl. G06F 9/50

(52) U.S. Cl. CPC G06F 9/5044; G06F 2209/503; G06F 2209/506; G06F 2209/509

(57) ABSTRACT

A distributed computing management function (DCMF) is configured to receive computing resource availability information from a first network node and transmit computing node information associated with the first network node to a second network node, wherein the second network node offloads one or more computing tasks to the first network node and the data for the one or more computing tasks does not traverse a core network.

### BACKGROUND

A fifth generation (5G) system architecture enables applications to access network edge computing services. Edge computing generally refers to an approach where data processing is localized towards the network edge within an edge hosting environment. It has been identified that certain types of applications and services (e.g., 5G, sixth generation (6G), etc.) may experience performance benefits from more agile computing and communication mechanisms. To improve performance and/or serve these types of applications and services a mobile network may be deployed that integrates computing and communication resources into the same network fabric.

### SUMMARY

Some exemplary embodiments are related to one or more processors of a distributed computing management function (DCMF) configured to receive computing resource availability information from a first network node and transmit computing node information associated with the first network node to a second network node, wherein the second network node offloads one or more computing tasks to the first network node and the data for the one or more computing tasks does not traverse a core network.

Other exemplary embodiments are related to a processor of a user equipment (UE) configured to transmit a request for computing resource availability to a distributed computing management function (DCMF) and receive computing node information associated with a network node, wherein the UE offloads one or more computing tasks to the network node and the data for the one or more computing tasks does not traverse a core network.

Still further exemplary embodiments are related to one or more processors of a computing node configured to transmit computing resource availability information to a distributed computing management function (DCMF) and establish a user plane with a user equipment (UE), wherein the UE offloads one or more computing tasks to the computing node and the data for the one or more computing tasks does not traverse a core network.

Additional exemplary embodiments are related to one or more processors of a network function configured to receive a registration request for one or more computing nodes from an application function and transmit a response to the request to the network function.

### BRIEF DESCRIPTION OF THE DRAWINGS

FIG. 1 shows an exemplary network arrangement according to various exemplary embodiments.

FIG. 2 shows an exemplary network arrangement according to various exemplary embodiments.

FIG. 3 shows an exemplary network architecture according to various exemplary embodiments.

FIG. 4 shows an exemplary user equipment (UE) according to various exemplary embodiments.

FIG. 5 shows an exemplary base station according to various exemplary embodiments.

FIG. 6 shows an exemplary signaling diagram for centralized node matching according to various exemplary embodiments.

FIG. 7 shows an exemplary signaling diagram for distributed node matching according to various exemplary embodiments.

FIG. 8 shows a signaling diagram for registering a computing node according to various exemplary embodiments.

FIG. 9 shows a signaling diagram for registering a DCAs according to various exemplary embodiments.

FIG. 10 shows a signaling diagram for resource discovery when using the centralized approach according to various exemplary embodiments.

FIG. 11 shows a signaling diagram for resource discovery when using the distributed node matching approach according to various exemplary embodiments.

FIG. 12 shows an exemplary application architecture according to various exemplary embodiments.

FIG. 13 shows an exemplary computing node architecture according to various exemplary embodiments.

### DETAILED DESCRIPTION

The exemplary embodiments may be further understood with reference to the following description and the related appended drawings, wherein like elements are provided with the same reference numerals. The exemplary embodiments introduce enhancements and techniques for implementing a network framework that integrates communication and computing resources in the same network fabric to enable ubiquitous computing. As will be described in more detail below, the exemplary ubiquitous computing functionality described herein may offer performance benefits compared to mechanisms that rely on a communication network and a computing environment that are two separate entities.

The exemplary embodiments are described with regard to a user equipment (UE). However, reference to a UE is provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

A fifth generation (5G) system architecture may enable the UE to access edge computing services. Those skilled in the art will understand that edge computing generally refers to performing computing and data processing at the network where the data is generated. In contrast to approaches that utilize a centralized architecture, edge computing is a distributed approach where data processing is localized towards the network edge, closer to the end user. For instance, the 5G system may route data traffic between the UE and an edge hosting environment to enable various different types of applications and services at the UE. However, it has been identified that certain types of applications and services (e.g., 5G, sixth generation (6G), etc.) may experience performance benefits from more agile communication and computing mechanisms.

The exemplary embodiments are also described with regard to a 6G network that integrates communication and computing resources into the same network fabric. This approach may enable ubiquitous computing functionality for the applications and services being used by the devices deployed within the network. For example, in contrast to a network architecture that primarily utilizes edge computing services, the exemplary embodiments may utilize computing resources from locations that span from on-device to the network edge and the computing nodes in between. However, reference to a 6G network is merely provided for illustrative purposes. The exemplary embodiments may be implemented by a 6G network, a 5G network or any other appropriate type of network that implements the type of functionalities described herein for ubiquitous computing.

Throughout this description, the term “computing node” may refer to a network node with computing resources. In some examples, the computing node may be part of a network communication node (e.g., relay node, radio access network (RAN) node) or a node hosted in an edge hosting environment. In other examples, a computing node may be part of the UE and further characterized as a “UE based computing node.” A UE may also be characterized as a network node with a computing need and there may be deployment scenarios where a single UE acts as a node with computing resources and a node with a computing need for one or more services.

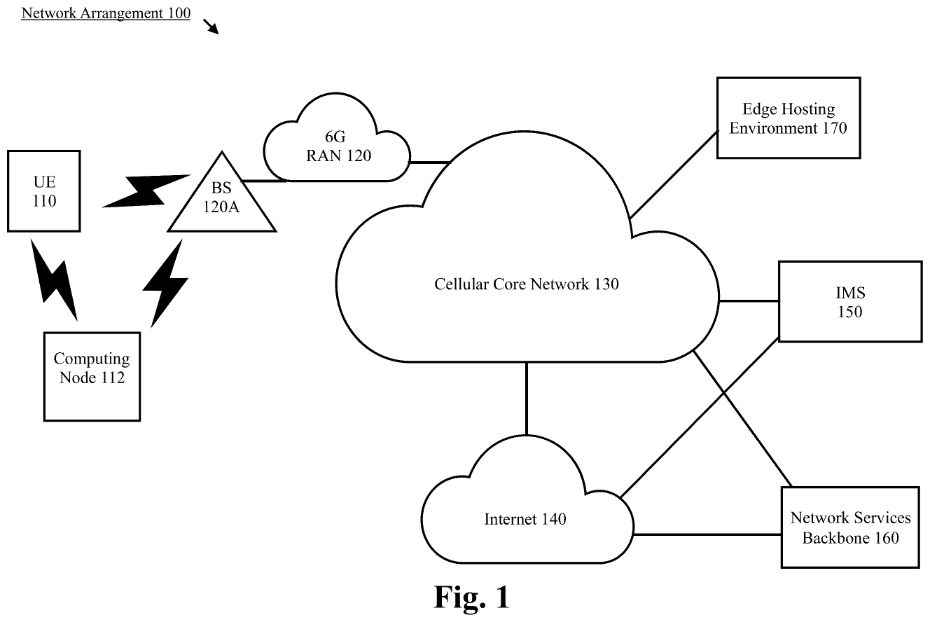

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IOT) devices, a smart speaker, head mounted display (HMD), augmented reality (AR) glasses, etc. It should also be understood that an actual network arrangement may include any number of UEs being used by any number of users. Thus, the example of a single UE 110 is merely provided for illustrative purposes.

The exemplary arrangement 100 also includes a computing node 112. In some examples, the computing node 112 may be a UE which is described above as any type of electronic component that is configured to communicate via a network, e.g., mobile phones, tablet computers, desktop computers, smartphones, phablets, embedded devices, wearables, Internet of Things (IoT) devices, smart speakers, multimedia devices, head mounted displays (HMDs), augmented reality (AR) glasses, etc. In the description of the example arrangement 100, the UE 110 is characterized as a device that may have a computing need. However, as mentioned above, the UE 110 may also serve as a computing node for itself and/or other devices.

To provide a general example, the UE 110 may have a computing need and the computing node 112 may be configured to serve the computing need of the UE 110. The computing node 112 may provide computing services for the UE 110 without the data traversing the core network 130 or any other network nodes (e.g., base station 120A, the RAN 120, etc.). However, the example provided above is merely for illustrative purposes and is not intended to limit the exemplary embodiments in any way. Specific examples regarding registering as a computing node in the network, determining resource availability at computing nodes, requesting computing resources and matching a request for resources with one or more computing node are provided in detail below.

In other examples, the computing node 112 may be part of an intermediate node. The intermediate node may as any type of electronic component that is configured to communicate with other network devices, e.g., a relay, an integrated access backhaul (IAB), a home server, a third-party deployed node, a drone, a component of a non-terrestrial network, etc. In this example, the computing node 112 may also provide computing services for the UE 110 without the data traversing the core network 130 or any other network nodes (e.g., base station 120A, the RAN 120, etc.). The example provided above is merely for illustrative purposes and is not intended to limit the exemplary embodiments in any way. Specific examples regarding registering as a computing node in the network, determining resource availability at computing nodes, requesting computing resources and matching a request for resources with one or more computing node are provided in detail below.

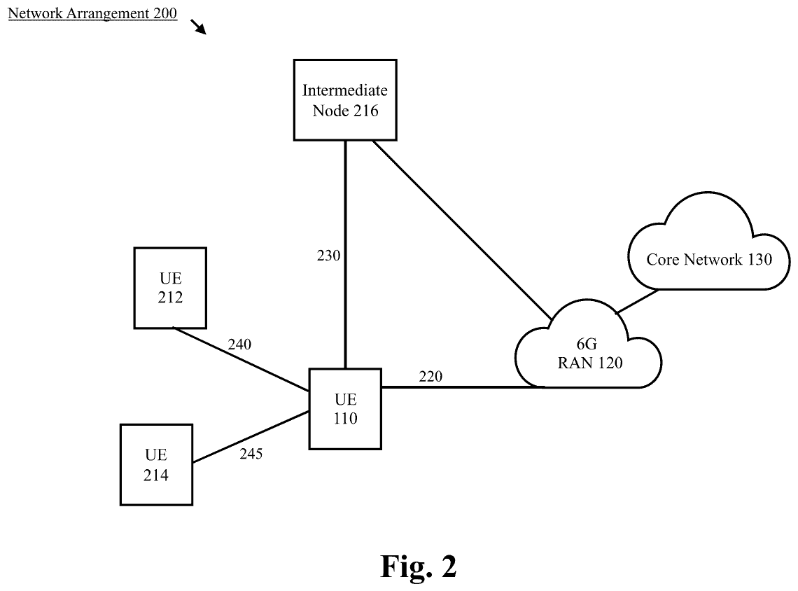

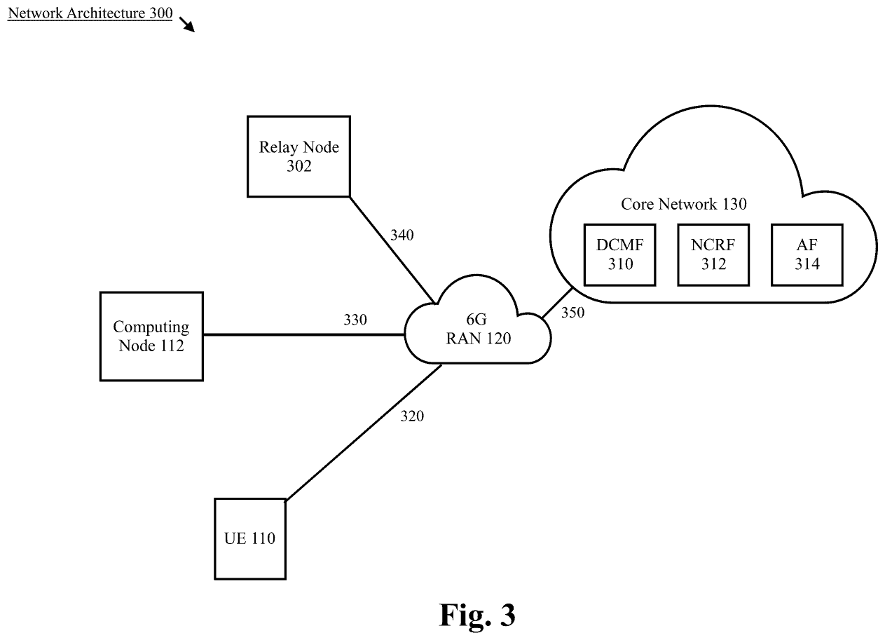

In further examples, the computing nodes may also be part of the RAN 120, the core network 130 or hosted in the edge hosting environment 170. Thus, reference to a single computing node 112 is merely provided for illustrative purposes, an actual network arrangement may include any number of computing nodes deployed at any appropriate virtual and/or physical location (e.g., within the mobile network operator's domain or within a third-party domain). Additional examples regarding the interactions and relationships between devices with computing needs (e.g., UE 110) and computing nodes are shown below in FIGS. 2-3.

The UE 110 may be configured to communicate with one or more networks. In the example of the network arrangement 100, the network with which the UE 110 may wirelessly communicate is a 6G radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 6G RAN 120. Therefore, the UE 110 may have a 6G chipset to communicate with the 6G RAN 120.

The 6G RAN 120 may be a portion of a cellular network that may be deployed by a network carrier. The 6G RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 6G RAN 120. For example, as discussed above, the 6G RAN 120 may be associated with a particular cellular provider where the UE 110 and/or the user thereof has a contract and credential information (e.g., stored on a SIM card). Upon detecting the presence of the 6G RAN 120, the UE 110 may transmit the corresponding credential information to associate with the 5G NR RAN 120. More specifically, the UE 110 may associate with a specific base station (e.g., base station 120A).

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC), the 5G core (5GC) and/or 6G core. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

In addition, the network arrangement 100 includes an edge hosting environment 170. The edge hosting environment may include various different types of devices, e.g., edge configuration server (ECS), edge data network, edge configuration server, etc. Those skilled in the art will understand that an actual network arrangement may include any appropriate number of edge hosting environments. Thus, the example of a single edge hosting environment 170 is merely provided for illustrative purposes.

FIG. 2 shows an exemplary network arrangement 200 according to various exemplary embodiments. The exemplary network arrangement 200 includes the UEs 110, 212, 214, intermediate node 216, the 6G RAN 120 and the core network 130. In this example, the UE 110 is a device with a computing need while the other devices (e.g., UEs 212-214, intermediate node 216) and nodes of the RAN 120, the core network 130 may serve as computing nodes for the UE 110. Although not shown in the network arrangement 200, a node deployed within an edge hosting environment may also serve as a computing node for UE 110.

According to some aspects, the exemplary embodiments relate to implementing a 6G network that integrates communication and computing resources into the same network fabric. This may include a distributed intelligent layer that collects and analyzes information on communication and computation resources in a mobile network to discover adequate resources and path to the resources for offloading computing tasks. Thus, in contrast to a legacy approach where the mobile network routes data to only an edge hosting environment for offloading computing tasks, the exemplary embodiments utilize a network that may offload to computing tasks to computing nodes located at various locations, e.g., ubiquitous computing.

In one exemplary scenario, a network-centric approach may be used for offloading computing tasks. For example, the UE 110 may have a computing need. The network may identify one or more network nodes that with computing resources that may be used to serve the computing needs of the UE 110. The network may then route this data via connection 220 to one or more computing nodes located within the RAN 120, the core network 130 and/or the edge hosting environment for processing. The example provided above is merely for illustrative purposes and is not intended to limit the exemplary embodiments in any way. Specific examples regarding registering as a computing node in the network, determining resource availability at computing nodes, requesting computing resources and matching a request for resources with one or more computing node are provided in detail below.

In another exemplary scenario, an intermediate node based approach may be used for offloading computing tasks. For example, the UE 110 may have a computing need. The network may identify one or more intermediate nodes (e.g., intermediate node 216) with computing resources that may be used to serve the computing needs of the UE 110. The network may then route data this data via connection 230 to the intermediate node 216 for processing without the data traversing the core network 130. From the perspective of the UE 110, the intermediate node 216 may be a trusted or untrusted device. The example provided above is merely for illustrative purposes and is not intended to limit the exemplary embodiments in any way. Specific examples regarding registering as a computing node in the network, determining resource availability at computing nodes, requesting computing resources and matching a request for resources with one or more computing node are provided in detail below.

In a further exemplary scenario, a device-centric approach may be used for offloading computing tasks. In one example, the UE 110 may be AR glasses or a head mounted display (HMD) that have a computing need. The UEs 212-214 may be other devices deployed within the vicinity of the user (e.g., laptop computer, home server, smart speaker, multimedia device, etc.). The network may identify one or more devices (e.g., UEs 212-214) with computing resources that may be used to serve the computing needs of the UE 110. The network may then route data this data via connections 240, 245 to the respective UEs 212-214 for processing without the data traversing the core network 130. From the perspective of the UE 110, the UEs 212-214 may be trusted or untrusted devices. The example provided above is merely for illustrative purposes and is not intended to limit the exemplary embodiments in any way. Specific examples regarding registering as a computing node in the network, determining resource availability at computing nodes, requesting computing resources and matching a request for resources with one or more computing node are provided in detail below.

FIG. 3 shows an exemplary network architecture 300 according to various exemplary embodiments. The following description will provide a general overview of the various components of the exemplary architecture 300. The specific operations performed by the components with respect to the exemplary embodiments will be described in greater detail after the description of the architecture 300.

The exemplary architecture 300 shows an example of the types of entities that may be used to implement an exemplary distributed intelligent layer that is able to perform tasks such as, but not limited to, collecting and analyzing information on communication and computing resources in a mobile wireless network, discovering available resources, determining a path between a device with a computing need and a device with computing resources and assisting in executing computing offload. As mentioned above with regard to the exemplary network arrangements 100-200 and as will be shown in more detail below, by integrating computing and communication resources in the same network fabric, the mobile network may utilize network operator provisioned, third party provisioned and/or user provisioned computing resources for a device with a computing need deployed within the network (e.g., the UE 110).

Those skilled in the art will understand that the components of the exemplary architecture 300 may reside in various physical and/or virtual locations relative to the network arrangement 100 of FIG. 1. These locations may include, within the access network (e.g., RAN 120), within the core network 130, as separate components outside of the locations described with respect to FIG. 1, etc.

In FIG. 3, the various components are shown as being connected via interfaces 320-350. It should be understood that these interfaces are not required to be direct wired or wireless connections, e.g., the interfaces may communicate via intervening hardware and/or software components. To provide an example, the UE 110 may exchange signals over the air with the base station 120A. However, in the architecture 300 the UE 110 is shown as having a connection to the RAN 120. This interface is not a direct communication link between the UE 110 and the RAN 120, instead, it is a connection that is facilitated by intervening hardware and software components. In another example, the interfaces may be implemented as a service based interface or an application program interface (API). Thus, throughout this description the terms “connection” and “interface” may be used interchangeably to describe the interfaces between the various components.

The architecture 300 includes the UE 110, the RAN 120, the computing node 112, a relay node 302 and the core network 130. The core network 130 includes a distributed computing management function (DCMF) 310, a network compute repository function (NCRF) 312 and an application function 314. Although not shown in the exemplary architecture 300, the core network 130 may also include other functions such as, but not limited to, a session management function (SMF), a registration function, an authentication function, a policy management function, a RAN management function, an analytics function, a network exposure function, a user plane function and a control plane function. However, any reference to the core network 130 including a particular type of function is merely provided for illustrative purposes.

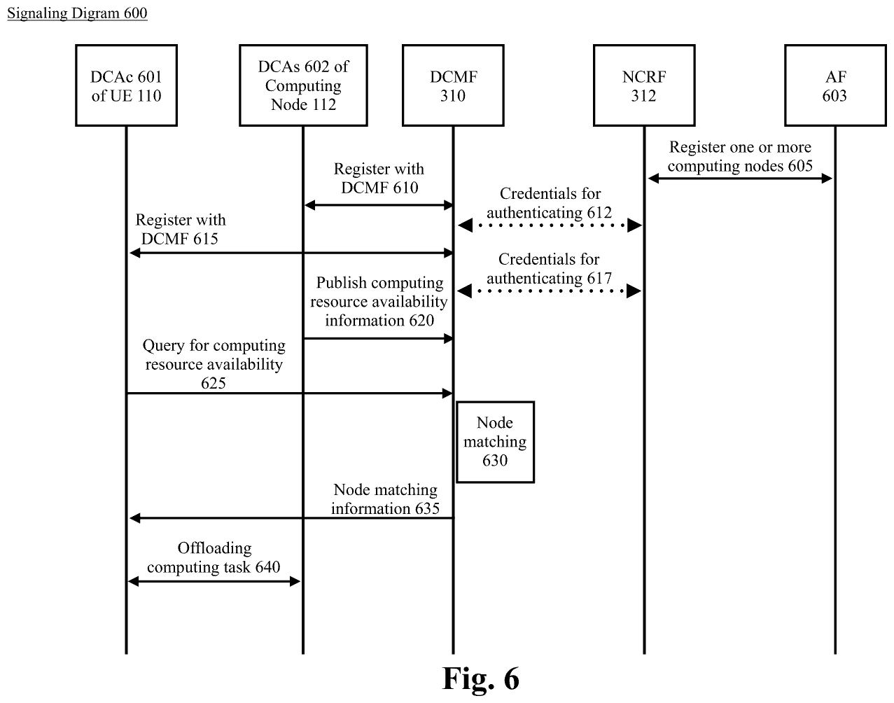

The DCMF 310 is generally responsible for onboarding, provisioning network nodes with computing resources and network nodes with computing needs. In addition, the DCMF 310 may also be responsible for discovery of adequate computing resources and communication paths. The DCMF 310 may also be configured to consider trust and privacy requirements from application providers and users when performing its operations. The exemplary embodiments are not limited to a DCMF that performs the above referenced operations. Specific examples of operations that may be performed by the DCMF are provided in detail below with regard to FIGS. 6, 7 and 9-13. However, reference to the term DCMF is merely provided for illustrative purposes, different entities may refer to similar concepts by a different name. Further, reference to a single DCMF 310 is merely for illustrative purposes, an actual network arrangement may include any appropriate number of DCMFs.

The NCRF 312 is generally responsible for registering network nodes with computing resources, aiding their onboarding and discovery. The NCRF 312 may include various enhancements to the 5G network repository function (NRF). The exemplary embodiments are not limited to a NCRF that performs the above referenced operations. Specific examples of operations that may be performed by the NCRF 312 are provided in detail below with regard to FIGS. 6-8. However, reference to the term NCRF is merely provided for illustrative purposes, different entities may refer to similar concepts by a different name. Further, reference to a single NCRF 312 is merely for illustrative purposes, an actual network arrangement may include any appropriate number of NCRFs.

The exemplary embodiments are also described with regard to distributed computing agent (DCA) which generally refers to entity that is embedded in network nodes that provides and/or requests computing resources. In some embodiments, the DCA may act as an application client (DCAc) and perform operations such as, but not limited to, requesting computing resources, receiving a response to the request indicating a computing node assigned to the DCAc or receiving a response to the request comprising information about candidate computing nodes. In other embodiments, the DCA may act as an application server (DCAs) and perform operations such as, but not limited to, publishing information about resource availability in the computing nodes and handling request for computing resources. A single entity may have both DCAc and DCAs active at the same time for different services. It should be understood that although the DCAc is referred to as an application client, from the perspective of the DCMF, the DCA (e.g., DCAc or DCAs) is a client entity.

Within the context of the network architecture 300, any of the network nodes may operate as a DCAc and/or DCAs. To provide a general example, consider one possible scenario in which the UE 110 has a computing need and thus, a DCA entity of the UE 110 may operate as a DCAc. In this example, the computing node 112 may be another UE (e.g., desktop, laptop, home server, etc.) with available computing resources. Thus, the DCA of the computing node 112 may operate as a DCAs for the DCAc of the UE 110. Similarly, the relay node 302 and the network nodes of the RAN 120 may also have available computing resources. Thus, the DCA of the relay node 302 and the network nodes of the RAN 120 may operate as a DCAs for the DCAc of the UE 110. In addition, although not shown in the network architecture 300, a node hosted in an edge hosting environment may also have available computing resources and operate as a DCAs for the DCAc of the UE 110. However, the above examples are merely provided for illustrative purposes and not intended to limit the exemplary embodiments in any way. The above example provides a general overview of possible interactions between the DCA of the UE 110 and the DCA of the other candidate computing nodes of the UE 110 within the exemplary network architecture 300 depicted in FIG. 3. Those skilled in the art will understand that there are a significant number of different possible arrangements of network nodes and scenarios in which the ubiquitous computing functionality described herein may be utilized.

The exemplary network architecture 300 may employ various techniques to ensure the privacy of the clients and the computing nodes processing their data. To provide some examples, the DCMF 310 may be configured such that it may not be aware of what the actual computing task to be performed comprises. Instead, the DCMF 310, the DCAs and the DCAc may handle computing tasks identified by a computing task ID provisioned by the application provider and/or application client. In another example, the communication path between the device with a computing need and a computing node may be managed by the mobile network. Thus, the device with the computing need may be unaware of where the computing node is situated. In addition, a trust level may control which computing nodes may be matched to a device with a computing need. However, the exemplary embodiments do not require nor are they limited to these privacy techniques. The exemplary embodiments may utilize any appropriate type of techniques to ensure the privacy of the clients and the computing nodes processing their data.

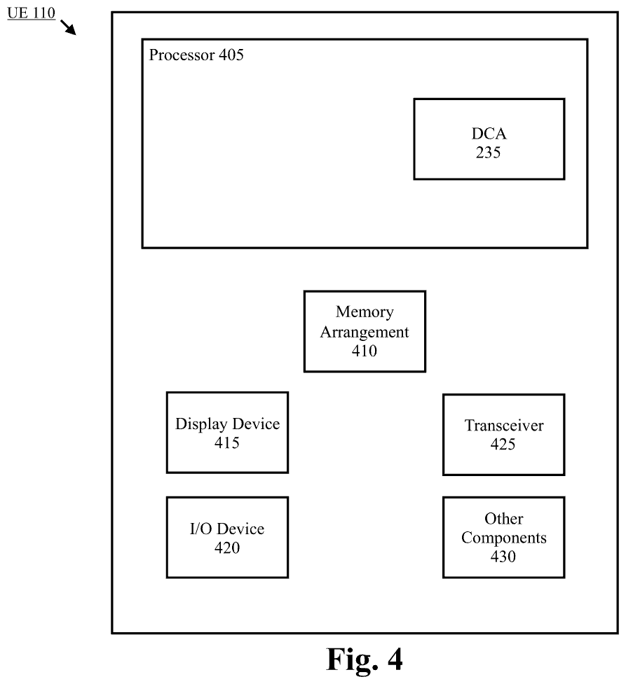

FIG. 4 shows an exemplary UE 110 according to various exemplary embodiments. The UE 110 will be described with regard to the network arrangement 100 of FIG. 1 and the network architecture 300 of FIG. 3. The UE 110 may include a processor 405, a memory arrangement 410, a display device 415, an input/output (I/O) device 420, a transceiver 425 and other components 430. The other components 430 may include, for example, an audio input device, an audio output device, a power supply, a data acquisition device, ports to electrically connect the UE 110 to other electronic devices, etc.

The processor 405 may be configured to execute various types of software. For example, the processor may execute a DCA 435. The DCA 435 may perform operations related to requesting and/or receiving computing resources. In some examples, the DCA 435 may operate as a DCAc and perform operations related to access computing resources. In other examples, the DCA 435 may operate as a DCAs and perform operations related to operating as a computing node for other network nodes. The UE 110 may have both DCAc and DCAs active at the same time for different services.

The above referenced software being executed by the processor 405 is only exemplary. The functionality associated with the software may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The software may also be embodied as one application or separate applications. In addition, in some UEs, the functionality described for the processor 405 is split among two or more processors such as a baseband processor and an applications processor. The exemplary embodiments may be implemented in any of these or other configurations of a UE.

The memory arrangement 410 may be a hardware component configured to store data related to operations performed by the UE 110. The display device 415 may be a hardware component configured to show data to a user while the I/O device 420 may be a hardware component that enables the user to enter inputs. The display device 415 and the I/O device 420 may be separate components or integrated together such as a touchscreen. The transceiver 425 may be a hardware component configured to establish a connection with the RAN 120, a 5G new radio (NR) RAN (not pictured), an LTE-RAN (not pictured), a legacy RAN (not pictured), a WLAN (not pictured), etc. Accordingly, the transceiver 425 may operate on a variety of different frequencies or channels (e.g., set of consecutive frequencies).

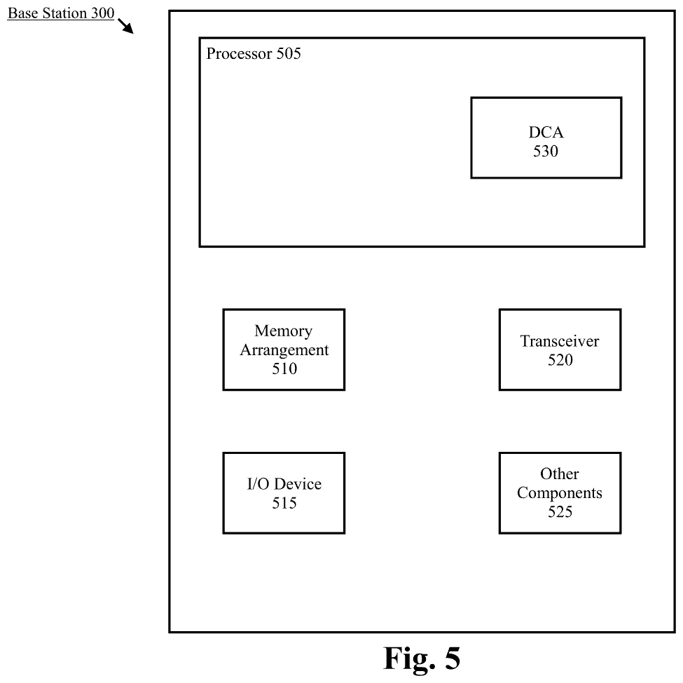

FIG. 5 shows an exemplary base station 500 according to various exemplary embodiments. The base station 500 may represent the base station 120A, the intermediate node 216, the relay node 302 or any other access node through which the UE 110 may establish a connection and manage network operations.

The base station 500 may include a processor 505, a memory arrangement 510, an input/output (I/O) device 515, a transceiver 520, and other components 525. The other components 525 may include, for example, an audio input device, an audio output device, a battery, a data acquisition device, ports to electrically connect the base station 500 to other electronic devices, etc.

The processor 505 may be configured to execute a plurality of engines for the base station 500. For example, the engines may include a DCA 530. The DCA 530 may perform various operations related to requesting and/or receiving computing resources.

The above references software 530 being executed by the processor 505 is only exemplary. The functionality associated with the engine 530 may also be represented as a separate incorporated component of the base station 500 or may be a modular component coupled to the base station 500, e.g., an integrated circuit with or without firmware. For example, the integrated circuit may include input circuitry to receive signals and processing circuitry to process the signals and other information. In addition, in some base stations, the functionality described for the processor 505 is split among a plurality of processors (e.g., a baseband processor, an applications processor, etc.). The exemplary embodiments may be implemented in any of these or other configurations of a base station.

The memory 510 may be a hardware component configured to store data related to operations performed by the base station 500. The I/O device 515 may be a hardware component or ports that enable a user to interact with the base station 500. The transceiver 520 may be a hardware component configured to exchange data with the UE 110 and any other network node within the network arrangement 100, the network architecture 300 or nodes outside of the locations described with respect to FIGS. 1 and 3. The transceiver 520 may operate on a variety of different frequencies or channels (e.g., set of consecutive frequencies). Therefore, the transceiver 520 may include one or more components (e.g., radios) to enable the data exchange with the various network nodes and UEs.

The exemplary network arrangements 100-200 of FIGS. 1-2 and the exemplary network architecture 300 of FIG. 3 described above included examples of the type of entities that may be utilized to enable the integration of computing and communication resources. The exemplary embodiments described below introduce various techniques that may be utilized by those exemplary entities to enable the network to implement the ubiquitous computing functionality described herein. According to some aspects, the exemplary embodiments introduce techniques for registering a computing node with the network. According to other aspects, the exemplary embodiments introduce techniques for collecting information related to computing resource availability amongst the computing nodes of the network. This may include techniques for the computing nodes to provide the computing resources availability information to the network and techniques for updating the computing resources availability information. In addition, the exemplary embodiments introduce techniques for devices with a computing need to request computing resources. This may include discovering computing nodes deployed throughout the network. According to other aspects, the exemplary embodiments introduce techniques for matching a request for computing resources with available computing resources at one or more computing nodes. Each of the exemplary techniques described herein may be used independently from one another, in conjunction with other currently implemented mechanisms for offloading computing tasks, future implementations of mechanisms for offloading computing tasks or independently from other mechanisms for offloading computing tasks.

Throughout this description, a computing task (or compute task) may be characterized by one or more of the following parameters. One exemplary parameter that may be used to characterize a computing task is a processor (e.g., central processing unit (CPU), graphical processing unit (GPU), etc.) requirement. For example, the processor requirement may indicate that the processing task is to be performed by a certain type of CPU or a certain number of resources (e.g., number of millicores, etc.). Another exemplary parameter that may be used to characterize a computing task is a memory requirement, e.g., a minimum number of gigabytes, etc. Another exemplary parameter that may be used to characterize a computing task is a time requirement. For example, the time requirement may indicate an amount of time the computing node would be expected to handle computing tasks (e.g., one-time computation, ongoing session, expected duration, periodically (stat time, duration, periodicity), a schedule, etc.).

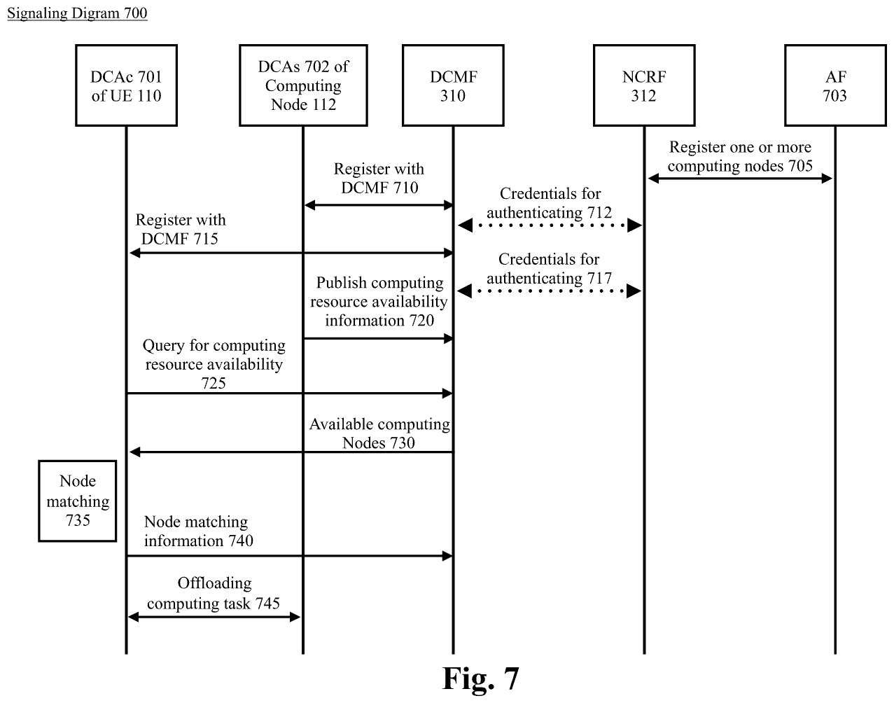

Initially, two different approaches for the discovery and matching of communications nodes with resources are provided below in FIGS. 6-7. FIG. 6 shows a signaling diagram for a centralized approach where the DCMF is responsible for performing the matching operation. For instance, the DCMF may manage the node matching procedure and select a computing node for the node requesting computing resources. FIG. 7 shows a signaling diagram for a distributed approach where a DCA is responsible for performing the matching operation. For instance, the node requesting the computing resources may manage the matching procedure using information provided from computing node indicating available computing resources.

FIG. 6 shows an exemplary signaling diagram 600 for centralized node matching according to various exemplary embodiments. The signaling diagram 600 includes a DCAc 601 of the UE 110, a DCAs 602 of the computing node 112, the DCMF 310, the NCRF 312 and an application function (AF) 603.

In 605, the AF 603 registers one or more computing nodes with the network. In this example, the NCRF 312 handles the registration for the network. However, in other examples, the AF 603 may register the one or more computing nodes with a network exposure function or any other appropriate type of network function.

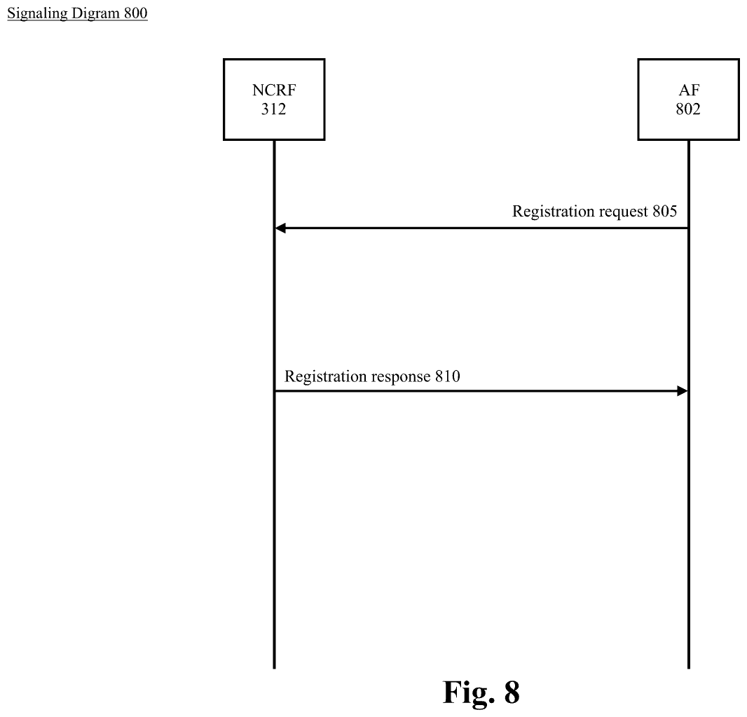

During the registration procedure, the AF 603 may provide the network with one or more messages comprising node level information. To provide some examples, node level information may include parameters such as, but not limited to, application ID, computing task ID, resource type (e.g., network based, UE based, relay node, etc.), node uniform resource identifier (URI), connectivity type (e.g., point-to-point (P2P), core network based, etc.) and credentials for authentication. In some embodiments, a network node may provide this type of information to the network. For example, the UE 110 may be configured as a UE based computing node may and provide this type of information to the network (e.g., NCFR 312, network exposure function, etc.) via non-access stratum (NAS) signaling. A specific example of a signaling exchange for registering one or more computing nodes with the network is provided below with regard to FIG. 8.

In 610, the DCAs 602 of the computing node 112 registers with the DCMF 310. The DCAs 602 may be triggered to initiate the registration procedure based on any appropriate type of event or predetermined condition. To provide some examples, the DCAs 602 may trigger the registration request based on the computing node 112 being powered on or based on user input.

The registration procedure may comprise authenticating the DCAs 602 of the computing node 112 to operate in the network as a computing node for devices with a computing need. In 612, during the registration procedure, the DCMF 310 may communicate with the NCRF 312 to obtain the credentials for authenticating the computing node 112. However, the DCMF 310 is not required to obtain these credentials during the registration procedure (if at all) and may obtain this type of information at any appropriate time and from any appropriate source.

In 615, the DCAc 601 of the UE 110 registers with the DCMF 310. The DCAc 601 may be triggered to initiate the registration procedure based on any appropriate type of event or predetermined condition. To provide some examples, the DCAc 601 may trigger the registration request based on the UE 112 being powered on, an application being launched at the UE 110 or based on user input.

The registration procedure may comprise authenticating the DCAc 601 of the UE 110 to operate in the network as a device to be served by a computing node. In 617, during the registration procedure, the DCMF 310 may communicate with the NCRF 312 to obtain the credentials for authenticating the UE 110. However, the DCMF 310 is not required to obtain these credentials during the registration procedure (if at all) and may obtain this type of information at any appropriate time and from any appropriate source.

In 620, the DCAs 602 publishes computing resource availability information. This information may include computing resource meta information such as, but not limited to, processing core information, memory information (e.g., peak, average, etc.), processing cost and a trust level (e.g., private, restricted, public, etc.). At this time, the DCMF 310 is aware of the resources available at computing node 112 for offloading computing tasks.

In 625, the DCAc 601 of the UE 110 may query the DCMF 310 for resource availability for offloading computing tasks. As mentioned above, a computing task may be characterized by a processor requirement (e.g., type of CPU, CPU resources, etc.), a memory requirement and/or a time requirement (e.g., one-time computation, ongoing session, expected duration, periodically (stat time, duration, periodicity), a schedule, etc.). The query or request may include parameters such as, but not limited to, application ID, computing task ID, resource type, trust level, computing task details (e.g., data size, etc.) and potential constraints (e.g., proximity to the UE 110, mobility requirements, financial cost, energy efficiency, etc.).

In 630, the DCMF 310 performs node matching in response to the query. For instance, the DCMF 310 may search for and identify candidate computing nodes for the DCAc 601 in a database comprising information based on computing resource availability information provided to the DCMF 310 from one or more candidate computing nodes deployed within the network. In this example, the DCMF 310 identifies and selects at least the computing node 112 as a candidate computing node for the UE 110. In 635, the DCMF 310 sends a message to the DCAc 601 of the UE 110 comprising the matching node information. This information may indicate to the UE 110 that there are available nodes for offloading computing tasks.

In 640, the UE 110 connects to the computing node 112 and offloads one or more computing tasks. The DCMF 310 may select a path to connect the UE 110 and the computing node 112 for offloading one or more computing tasks. In some embodiments, the DCMF 310 may work with an SMF of the network to find an adequate path for the UE 110 to the computing node 112. However, the DCMF 310 is not required to work with a SMF and may work with any appropriate number of network nodes to discover the path between the UE 110 and the computing node 112. The DCMF 310 may send information to the UE 110 to enable the UE 110 to connect to the computing node 112 for computing task offloading in the node matching information. In other embodiments, the network may provide this type of information using radio resource control (RRC) signaling, system information, NAS signaling or any other appropriate type of mechanism.

FIG. 7 shows an exemplary signaling diagram 700 for distributed node matching according to various exemplary embodiments. The signaling diagram 700 includes a DCAc 701 of the UE 110, a DCAs 702 of the computing node 112, the DCMF 310, the NCRF 312 and an AF 703.

In 705, the AF 703 registers one or more computing nodes with the network. In this example, the NCRF 312 handles the registration for the network. However, in other examples, the AF 703 may register the one or more computing nodes with a network exposure function or any other appropriate type of network function.

During the registration procedure, the AF 703 may provide the network with one or more messages comprising node level information. To provide some examples, node level information may include parameters such as, but not limited to, application ID, computing task ID, resource type (e.g., network based, UE based, relay node, etc.), node URI, connectivity type (e.g., P2P, core network based, etc.) and credentials for authentication. In some embodiments, a network node may provide this type of information to the network. For example, the UE 110 may be configured as a UE based computing node and may provide this type of information to the network (e.g., NCFR 312, network exposure function, etc.) via NAS signaling. A specific example of a signaling exchange for registering one or more computing nodes with the network is provided below with regard to FIG. 8.

In 710, the DCAs 702 of the computing node 112 registers with the DCMF 310 as a computing node. The DCAs 702 may be triggered to initiate the registration procedure based on any appropriate type of event or predetermined condition. To provide some examples, the DCAs 702 may trigger the registration request based on the computing node 112 being powered on or based on user input.

The registration procedure may comprise authenticating the DCAs 702 of the computing node 112 to operate in the network as a computing node for devices with a computing need. In 712, during the registration procedure, the DCMF 310 may communicate with the NCRF 312 to obtain the credential for authenticating the computing node 112. However, the DCMF 310 is not required to obtain these credentials during the registration procedure (if at all) and may obtain this type of information at any appropriate time and from any appropriate source.

In 715, the DCAc 701 of the UE 110 registers with the DCMF 310 as a device with a potential computing need. The DCAc 701 may be triggered to initiate the registration procedure based on any appropriate type of event or predetermined condition. To provide some examples, the DCAc 701 may trigger the registration request based on the UE 112 being powered on, an application being launched at the UE 110 or based on user input.

The registration procedure may comprise authenticating the DCAc 701 of the UE 110 to operate in the network as a device to be served by a computing node. In 717, during the registration procedure, the DCMF 310 may communicate with the NCRF 312 to obtain the credential for authenticating the UE 110. However, the DCMF 310 is not required to obtain these credentials during the registration procedure (if at all) and may obtain this type of information at any appropriate time and from any appropriate source.

In 720, the DCAs 702 publishes computing resource availability information. This information computing resource meta information such as, but not limited to, processing core information, memory information (e.g., peak, average, etc.), processing cost and a trust level (e.g., private, restricted, public, etc.). At this time, the DCMF 310 is aware of the resources available at computing node 112 for offloading computing tasks.

In 725, the DCAc 701 of the UE 110 may query the DCMF 310 for resource availability for offloading computing tasks. As mentioned above, a computing task may be characterized by a processor requirement (e.g., type of CPU, CPU resources, etc.), a memory requirement and/or a time requirement (e.g., one-time computation, ongoing session, expected duration, periodically (stat time, duration, periodicity), a schedule, etc.). The query or request may include parameters such as, but not limited to, application ID, computing task ID, resource type, trust level, computing task details (e.g., data size, etc.) and potential constraints (e.g., proximity to the UE 110, mobility requirements, financial cost, energy efficiency, etc.).

The DCAc 701 of the UE 110 may subscribe to the DCMF 310 for available computing nodes matching the parameters provided in the query. Once subscribed, in 730, one or more available computing nodes are indicated to the UE 110. This information may be pushed to the UE 110 periodically by the DCMF 310. In some embodiments, when determining which computing nodes are appropriate for the UE 110, the DCMF 310 may consider trust level, resource availability, network conditions, any constraints provided by the UE 110 and/or any other appropriate factor.

In 735, the DCAc 701 of the UE 110 performs node matching. This may include selecting one or more computing nodes that have been previously indicated by the DCMF 310 and match a computing task need of the UE 1110. In the example, the DCAc 701 selects the DCAs 702 of the computing node 112 for offloading computing tasks. However, reference to a single DCAs being selected is merely provided for illustrative purposes. Any appropriate number of computing nodes may be selected by the DCAc 701 for offloading computing tasks.

In 740, the DCAc 701 sends a message to the DCMF 310 indicating that one or more computing nodes have been selected for offloading computing tasks. In 745, the UE 110 connects to the computing node 112 and offloads one or more computing tasks. The DCMF 310 may select a path to connect the UE 110 and the computing node 112 for offloading one or more computing tasks. In some embodiments, the DCMF 310 may work with an SMF of the network to find an adequate path for the UE 110 to the computing node 112. However, the DCMF 310 is not required to interface with a SMF and may interface with any appropriate number of network nodes to discover the path between the UE 110 and the computing node 112. The DCMF 310 may send information to the UE 110 to enable the UE 110 to connect to the computing node 112 for offloading computing tasks when sending the information regarding the available computing nodes in 730. In other embodiments, the network may provide this type of information using RRC signaling, system information, NAS signaling or any other appropriate type of mechanism.

FIG. 8 shows a signaling diagram 800 for registering a computing node according to various exemplary embodiments. The signaling diagram 800 includes an AF 802 and the NCRF 312 and provides an example of the registration procedures shown in 605 of the signaling diagram 600 and 705 of the signaling diagram 700.

In 805, the AF 802 transmits a registration request to the NCRF 312. This request may be referred to as an “ComputeNodeRegistration CreateREQ” and include parameters such as, but not limited to, node URI, data network access identifier (DNAI), application ID, computing task IDs, resource type, connectivity type, etc. This registration procedure allows an entity to on-board computing resources into the mobile network operator's network.

In 810, the NCRF 312 transmits a response to the request to the AF 802. This response may be referred to as an “ComputeNodeRegistration_CreateCNF” and indicates whether the registration is a success or failure. In this example, it is assumed that the registration procedure is a success. However, in an actual deployment scenario, the network may reject the request for any appropriate reason.

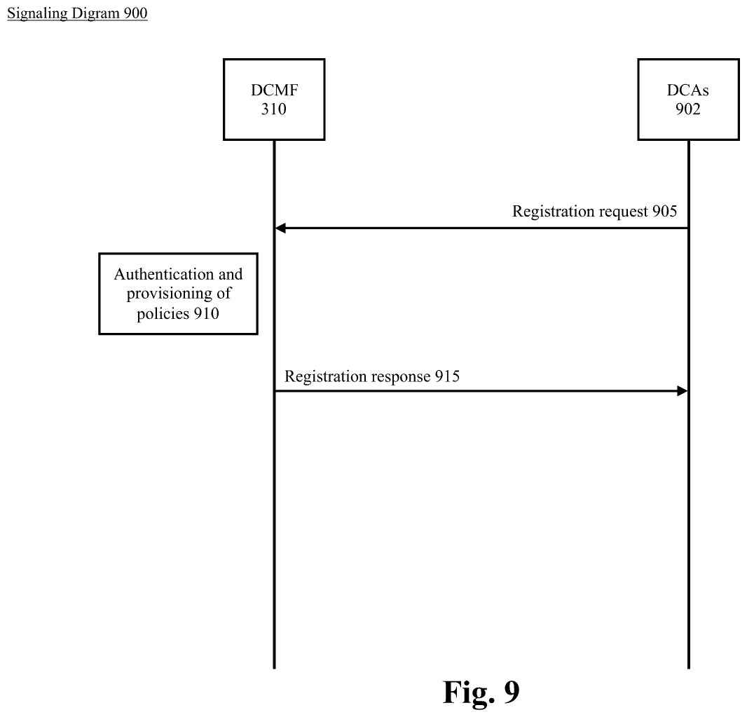

FIG. 9 shows a signaling diagram 900 for registering a DCAs according to various exemplary embodiments. The signaling diagram 900 includes a DCAs 902 and the DCMF 310 and provides an example of the registration procedure shown in 610 of the signaling diagram 600 and the registration procedure shown in 710 of the signaling diagram 700.

As mentioned above, the DCAs may be triggered to initiate the registration procedure based on the occurrence of an event and/or condition. For example, the DCAs 902 may register with the DCMF 310 of the mobile network operator at start-up. The registration procedure may enable the network to authenticate the DCAs 902 and provision network specific policies to the DCAs 902. On successful completion of the registration procedure, the node may be assigned a temporary identifier referred to in the example as “TempNodeID.”

In 905, the DCAs 902 transmits a registration request to the DCMF 310. This request may be referred to as a “ComputeNodeRegister” request and include parameters such as, but not limited to, node URI, application ID, computing task IDs, compute resource availability information and security information.

In 910, the DCMF 310 may perform authentication and provisioning of policies for operation in the network. As mentioned above, this may include communicating with the NCRF or any other appropriate type of network function to obtain the authentication parameters. In 915, the DCMF 310 transmits a response to the request to the DCAs 902. This response may be referred to as an “ComputeNodeRegisterCNF” and indicates whether the registration is a success or failure. In this example, it is assumed that the registration procedure is a success. However, in an actual deployment scenario, the network may reject the request for any appropriate reason. In addition, the response may include a TempNodeID and any other appropriate type of parameter.

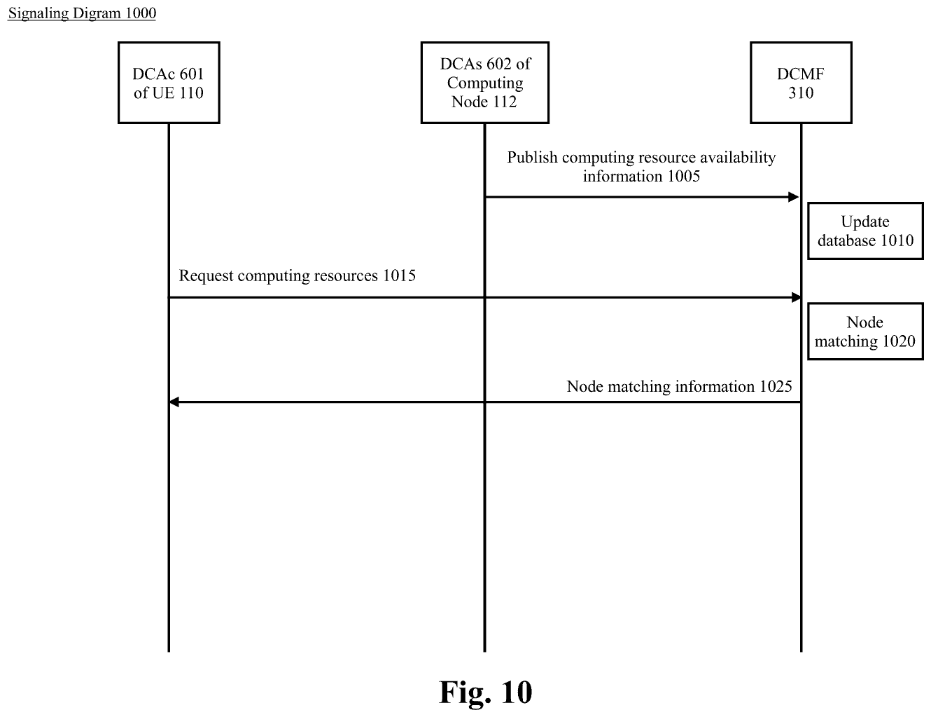

FIG. 10 shows a signaling diagram 1000 for resource discovery when using the centralized node matching approach according to various exemplary embodiments. A more general overview of the centralized node matching approach was described above with regard to the signaling diagram 600 of FIG. 6. The signaling diagram 1000 provides additional details with regard to the interactions that may occur between the DCAc 601 of the UE 110, the DCAs 602 of the computing node 112 and the DCMF 310 for resource discovery within the context of the examples described above with regard to the centralized node matching approach shown in the signaling diagram 600.

Initially, assume that both the DCAc 601 of the UE 110 and the DCAs 602 of the computing node 112 have already been authenticated within the network. During operation, in 1005, the DCAs 602 of the computing node 112 publishes resource availability information to the DCMF 310. The DCAs 602 may publish this resource availability information periodically, in response to an event, based on a predetermined condition or based on any other appropriate factor. In this example, this message is referred to as “PublishComputeResources” which may further include parameters such as, but not limited to, TempNodeID, computing task ID, trust level information and any constraints. Throughout this description, trust level information may relate to the trust computing resource and indicate whether the computing resource is private, restricted or public. In addition, the trust level information may also include group membership information for private and restricted computing resources, security parameters (to validate group membership) and isolation levels of the computing resources (e.g., core separation, task separation, etc.).

In 1010, the DCMF 310 updates a database comprising information about computing nodes deployed within the network. The DCMF 310 may update an entry in the database associated with the DCAs 602 of the computing node 112 based on the resource availability information published by the DCAs 602 of the computing node 112.

In 1015, the DCAc 601 of the UE 110 sends a RequestComputeResources to the DCMF 310. In 1020, the DCMF 310 performs the match procedure to find an appropriate computing node for the request. In 1025, the DCMF 310 sends a ComputeResourcesCNF to the DCAc 601 of the UE 110 to inform the DCAc 601 about the discovered one or more computing nodes (e.g., node matching information). In some embodiments, the DCMF 310 may also provide connectivity information to the UE 110 that enables the UE 110 to reach the computing node 112 using either a network based connection or a direct connection where the data does not traverse the core network 130.

Alternatively, or in addition to the connectivity information, the DCMF 310 may work with an SMF in the network to setup a suitable user plane path for the UE 110 to reach the computing node 112 for offloading one or more computing tasks. In other embodiments, the UE 110 may use a UE initiate packet data unit (PDU) session establishment or modification procedure to setup a user plane path to the computing node 112 for offloading one or more computing tasks.

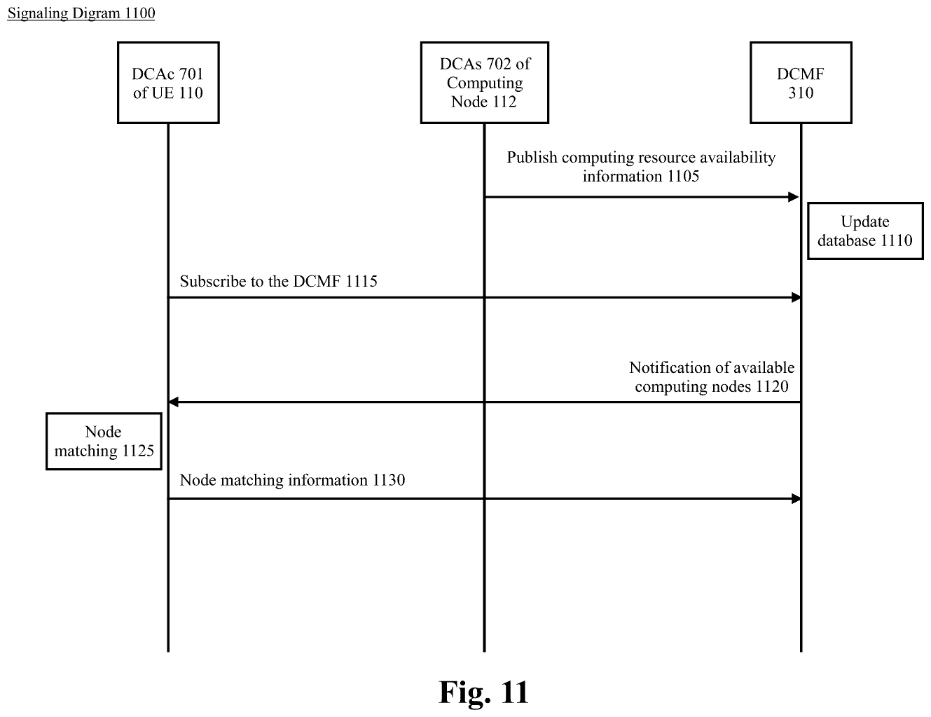

FIG. 11 shows a signaling diagram 1100 for resource discovery when using the distributed node matching approach according to various exemplary embodiments. A more general overview of the distributed node approach was described above with regard to the signaling diagram 700 of FIG. 7. The signaling diagram 1100 provides additional details with regard to the interactions between the DCAc 701 of the UE 110, the DCAs 702 of the computing node 112 and the DCMF 310 for resource discovery within the context of the examples described above with regard to the distributed node matching approach shown in the signaling diagram 700.

Initially, assume that both the DCAc 701 of the UE 110 and the DCAs 702 of the computing node 112 have already been authenticated within the network. During operation, in 1105, the DCAs 702 of the computing node 112 publishes resource availability information to the DCMF 310. The DCAs 702 may publish this resource availability information periodically, in response to an event, based on a predetermined condition or based on any other appropriate factor. In this example, like in the signaling diagram 1000 this message may be referred to as “PublishComputeResources” which may further include parameters such as, but not limited to, TempNodeID, computing task ID, trust level information and any constraints. As mentioned above, trust level information may relate to the trust computing resource and indicate whether the computing resource is private, restricted or public. In addition, the trust level information may also include group membership information for private and restricted computing resources, security parameters (to validate group membership) and isolation levels of the computing resources (e.g., core separation, task separation, etc.).

In 1110, the DCMF 310 updates a database comprising information about computing nodes deployed within the network. The DCMF 310 may update an entry in the database associated with the DCAs 702 of the computing node 112 based on the resource availability information published by the DCAs 702 of the computing node 112.

In 1115, the DCAc 701 of the UE 110 subscribes to the DCMF 310. The subscription to the DCMF 310 may ensure that the DCMF 310 informs the DCAc 701 about suitable computing nodes that may be available in the network. In this example, this message may be referred to as “ComputeResources_Subscribe” and comprise parameters such as, but not limited to, a TempNodeID, computing task IDs, compute resource requirements, compute resource constraints and trust level information.

In 1120, the DCMF 310 notifies the DCAc 701 about available computing nodes for offloading computing tasks. The DCMF 310 may identify and select one or more computing nodes to send to the DCAc 701 based on the subscription request and/or any other appropriate type of information. In this example, this message may be referred to as “ComputeResources_Notify” and comprise parameters such as, but not limited to, a TempNodeID and a list of computing node IDs. The DCMF 310 may provide this notification to the DCAc 701 periodically, in response to an event, based on a predetermined condition or based on any other appropriate factor.

In 1125, the DCAc 701 performs the node matching procedure to find an appropriate computing node for offloading computing tasks.

In 1130, the DCAc 701 sends a message to the DCMF 310 informing the DCMF 310 of the computing node selected by the DCAc 701 (e.g., node matching information). In this example, the DCAc 701 selects the computing node 112. This exemplary message may be referred to as “ComputeResource_Inform” and comprise parameters such as, but not limited to, a TempNodeID and one or more selected computing node IDs.

As mentioned above, the DCMF 310 may selects a path to connect the UE 110 and the computing node 112. In some embodiments, the network may also select one or more data network connectivity modifications. The DCMF 310 may interface with an SMF in the network to setup a suitable user plane path for the UE 110 to reach the computing node 112 for offloading one or more computing tasks. In other embodiments, the UE 110 may initiate a packet data unit (PDU) session establishment or modification procedure to setup a user plane path to the computing node 112 for offloading one or more computing tasks.

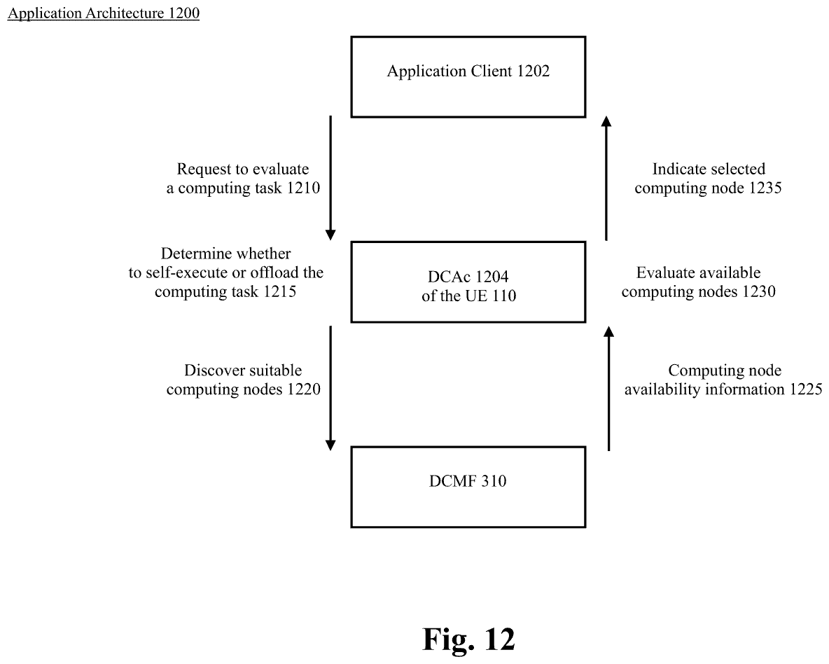

FIG. 12 shows an exemplary application architecture 1200 according to various exemplary embodiments. The exemplary application architecture 1200 includes an application client 1202 running on the UE 110, a DCAc 1204 of the UE 110 and the DCMF 310. This exemplary application architecture 1200 may utilize the ubiquitous computing framework described herein.

In 1210, the application client 1202 may request that the DCAc 1204 evaluates a computing task to determine whether to self-execute the task or offload the computing task to a suitable computing node. In 1215, the DCAc 1204 determines whether to self-execute the task. This determination may be performed on the basis of CPU consumption at the UE 110, power consumption at the UE 110, available local memory at the UE 110, temperature of the UE 110, etc. For example, the DCAc 1204 may compute a cost for self-executing the computing task with the application processor of the UE 110 and/or the power management functions in the UE 110. However, this example is merely provided for illustrative purposes, the DCAc 1204 may make this determination based on any appropriate basis.

In 1220, the DCAc 1204 contacts the DCMF 310 to discover suitable computing nodes for the UE 110 to offload one or more computing tasks. The DCMF 310 may then identify and select one or more computing nodes that may serve the computing needs of the UE 110. In 1225, the DCMF 310 provides the computing node availability information to the DCAc 1204.

In 1230, the DCAc 1204 performs an evaluation of the available computing nodes. In this example, the distributed node matching approach is utilized and thus, the DCAc 1204 selects the computing nodes that may be utilized for offloading. To select the computing node for offloading the DCAc 1204 may consider parameters such as, but not limited to, connectivity parameters (e.g., latency, throughout, etc.), cost (e.g., financial, energy, power, etc.) and attributes of the computing nodes (e.g., trust level, etc.). In 1235, the DCAc 1204 provides the decision to the application client 1202.

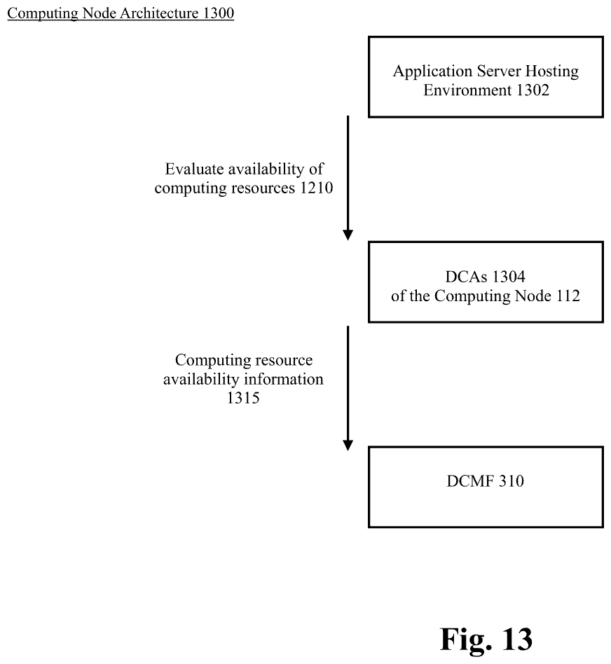

FIG. 13 shows an exemplary computing node architecture 1300 according to various exemplary embodiments. The exemplary application architecture 1300 includes an application server hosting environment 1302 of the computing node 112, a DCAs 1304 of the computing node 112 and a DCMF 310.

In 1310, the application server hosting environment 1302 may evaluate the availability of computing resources at the computing node 112 and provide this information to the DCAs 1304. This evaluation may be performed on the instantaneous load at the computing node 112 and/or a prediction of future resources availability at the computing node 112. For example, the predicted future outlook may be based on when currently executed computing tasks are expected to end, relocating computing tasks to other nodes, etc.

In 1315, the DCAs 1304 may transmit a message to the DCMF 310 comprising computing resource availability information. The DCAs 1304 may publish this resource availability information periodically, in response to an event, based on a predetermined condition or based on any other appropriate factor.

### EXAMPLES

In a first example, a method performed by a distributed computing management function (DCMF), comprising receiving computing resource availability information from a first network node and transmitting computing node information associated with the first network node to a second network node, wherein the second network node offloads one or more computing tasks to the first network node and the data for the one or more computing tasks does not traverse a core network.

In a second example, the method of the first example, further comprising receiving, prior to transmitting the computing node information associated with the first network node to a second network node, a query for computing resource availability from the second network node.

In a third example, the method of the second example, wherein the query comprises at least one or more of a computing task ID, an application ID and a computing resource type.

In a fourth example, the method of the second example, wherein the query comprises information related to a computing task to be offloaded by the second network node including at least a data size to be processed.

In a fifth example, the method of the second example, wherein the query comprises constraints related to selecting a computing node for a computing task to be offloaded by the second network node, wherein the constrains include at least one of proximity, mobility, cost and energy efficiency.

In a sixth example, the method of the second example, further comprising matching the first network node and the second network node in response to the query, wherein the matching comprises selecting the first network node from a centralized database.

In a seventh example, the method of the sixth example, wherein the selecting the first network node from the centralized database is based on trust level information associated with the first network node.

In an eighth example, the method of the first example, further comprising determining a user plane path between the first network node and the second network node, wherein the user plane path is utilized for offloading one or more computing tasks from the second network node to the first network node.

In a ninth example, the method of the first example further comprising receiving, prior to transmitting the computing node information associated with the first network node to a second network node, a subscription request from the second network node for computing node availability information.

In a tenth example, the method of the ninth example, wherein the DCMF periodically transmits the computing node availability information based on subscription information for the second network node.

In an eleventh example, the method of the first example further comprising receiving matching node information from the second network node, wherein the second network node selects a computing node for offloading computing tasks based on the computing node availability information.

In a twelfth example, the method of the eleventh example further comprising receiving matching node information from the second network node, wherein the second network node selects a computing node for offloading computing tasks based on at least one of a trust level, a proximity, a cost and energy efficiency.

In a thirteenth example, the method of the twelfth example, wherein the at least one of the trust level, the proximity, the cost and the energy efficiency is locally determined by the second node.

In a fourteenth example, the method of the first example, further comprising receiving a registration request from the first network node, authenticating the first network node in response to the request and transmitting a temporary node identifier to the first network node based on a successful registration procedure.

In a fifteenth example, the method of the fourteenth example, wherein registration request comprises at least one or more of an application ID, a compute task ID, compute resource availability information and security information.

In a sixteenth example, the method of the fourteenth example, wherein the DCMF obtains parameters for authentication of the first network node from a network compute repository function (NCRF) or a network exposure function.

In a seventeenth example, the method of the first example, further comprising receiving a registration request from the second network node, authenticating the second network node in response to the request and transmitting a temporary node identifier to the second network node based on a successful registration procedure.

In an eighteenth example, the method of the seventeenth example, wherein the DCMF obtains parameters for authentication of the first network node from a network compute repository function (NCRF) or a network exposure function.

In a nineteenth example, one or more processors configured to perform any of the methods of the first through eighteenth examples.

In a twentieth example, one or more apparatuses comprising one or more processors configured to perform any of the methods of the first through eighteenth examples.

In a twenty first example, a method performed by a user equipment (UE), comprising transmitting a request for computing resource availability to a distributed computing management function (DCMF) and receiving computing node information associated with a network node, wherein the UE offloads one or more computing tasks to the network node and the data for the one or more computing tasks does not traverse a core network.

In a twenty second example, the method of the twenty first example, wherein the request is a query comprising at least one or more of a computing task ID, an application ID and a computing resource type.

In a twenty third example, the method of the twenty first example, wherein the request is a query comprising information related to a computing task to be offloaded by the second network node including at least a data size to be processed.

In a twenty fourth example, the method of the twenty first example, wherein the request is a query comprising information related to a computing task to be offloaded by the second network node including at least a data size to be processed.

In a twenty fifth example, the method of the twenty first example, wherein the request is a query comprising constraints related to selecting a computing node for a computing task to be offloaded by the second network node, wherein the constrains include at least one of proximity, mobility, cost and energy efficiency.

In a twenty sixth example, the method of the twenty first example, wherein the DCMF matches the UE with the network node for offloading one or more computing tasks.

In a twenty seventh example, the method of the twenty first example, wherein the request is a subscription request for computing node availability information.

In a twenty eighth example, the method of the twenty seventh example, wherein the DCMF periodically transmits the computing node availability information based on subscription information for the second network node.

In a twenty ninth example, the method of the twenty seventh example, further comprising selecting the network node for offloading computing tasks based on the computing node availability information.

In a thirtieth example, the method of the twenty ninth example, further comprising transmitting matching node information to the DCMF in response to selecting the network node for offloading computing tasks.

In a thirty first example, the method of the twenty first example, further comprising transmitting a registration request to the DCMF, wherein the DCMF, authenticates the second network node in response to the request and receiving a temporary node identifier based on a successful registration procedure.

In a thirty second example, the method of the thirty first example, wherein the DCMF obtains parameters for authentication of the first network node from a network compute repository function (NCRF) or a network exposure function.

In a thirty third example, the method of the twenty first example, further comprising initiating packet data unit (PDU) session establishment or PDU session modification to establish a user plane path between the UE and the network node, wherein the user plane path is utilized for offloading one or more computing tasks from the UE to the network node.

In a thirty fourth example, the method of the twenty first example, wherein a distributed computing agent (DCA) of the UE determines whether a first computing task is to be self-executed or offloaded prior to transmitting the request to the DCMF.

In a thirty fifth example, the method of the thirty fourth example, wherein determining whether a first computing task is to be self-executed or offloaded is based on at least one or more of a power consumption parameter, a CPU consumption parameter and a memory availability parameter.

In a thirty sixth example, one or more processors configured to perform any of the methods of the twenty first through thirty fifth examples.

In a thirty seventh example, a user equipment (UE) comprising a transceiver configured to communicate with a network and one or more processors communicatively coupled to the transceiver and configured to perform any of the methods of the twenty first through thirty fifth examples.

In a thirty eighth example, a method performed by a computing node, comprising transmitting computing resource availability information to a distributed computing management function (DCMF) and establishing a user plane with a user equipment (UE), wherein the UE offloads one or more computing tasks to the computing node and the data for the one or more computing tasks does not traverse a core network.

In a thirty ninth example, the method of the thirty eighth example, further comprising transmitting a registration request to the DCMF, wherein the DCMF authenticates the computing node in response to the request and receiving a temporary node identifier from the DCMF based on a successful registration procedure.

In a fortieth example, the method of the thirty ninth example, wherein the registration request comprises at least one or more of an application ID, a compute task ID, compute resource availability information and security information.

In a forty first example, the method of the thirty ninth example, wherein the DCMF obtains parameters for authentication of the computing node from a network compute repository function (NCRF) or a network exposure function.

In a forty second example, the method of the thirty eighth example, wherein the computing resource availability information indicates at least one of an instantaneous load on an application server of the computing node, information associated with executing computing tasks that are to be completed and information associated with computing tasks that are to be relocated.

In a forty third example, the method of the thirty eighth example, wherein the computing node periodically publishes the computing resource availability information to the DCMF.

In a forty fourth example, one or more processors configured to perform any of the methods of the thirty eighth through forty third examples.

In a forty fifth example, a computing node comprising a transceiver and one or more processors communicatively coupled to the transceiver and configured to perform any of the methods of the thirty eighth through forty third examples.

In a forty sixth example, a method performed by a network function, comprising receiving a registration request for one or more computing nodes from an application function and transmitting a response to the request to the network function.

In a forty seventh example, the method of the forty sixth example, wherein the network function is a network compute repository function (NCRF).

In a forty eighth example, the method of the forty sixth example, wherein the network function is a network exposure function.

In a forty ninth example, the method of the forty sixth example, wherein the request comprises at least one or more of a node uniform resource identifier (URI), data network access identifier (DNAI), application ID, computing task IDs, resource type and connectivity type.

In a fiftieth example, the method of the forty sixth example, further comprising transmitting credentials for authenticating a network node to a distributed computing management function (DCMF).

In a fifty first example, the method of the fiftieth example, wherein the network node is a user equipment (UE) with a computing resource need.

In a fifty second example, the method of the fiftieth example, wherein the network node is a computing node with a computing resource availability.

In a fifty third example, one or more processors configured to perform any of the methods of the forty sixth through fifty second examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

As described above, one aspect of the present technology is the gathering and use of data available from specific and legitimate sources. The present disclosure contemplates that in some instances, this gathered data may include personal information data that uniquely identifies or can be used to identify a specific person. Such personal information data can include location data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, location data of other users (e.g., the application specific data) may be used to improve node matching between computing nodes and devices with computing needs.

The present disclosure contemplates that those entities responsible for the collection, analysis, disclosure, transfer, storage, or other use of such personal information data will comply with well-established privacy policies and/or privacy practices.

In particular, such entities would be expected to implement and consistently apply privacy practices that are generally recognized as meeting or exceeding industry or governmental requirements for maintaining the privacy of users. Such information regarding the use of personal data should be prominent and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the DCMF may be configured such that it may not be aware of what the actual computing task to be performed comprises. Instead, the DCMF, the DCAs and the DCAc may handle computing tasks identified by a computing task ID provisioned by the application provider and/or application client. In another example, the communication path between the device with a computing need and a computing node may be managed by the mobile network. Thus, the device with the computing need may be unaware of the location of the computing node. In addition, a trust level may control which computing nodes may be matched to a device with a computing need.

It is the intent of the present disclosure that personal information data should be managed and handled in a way to minimize risks of unintentional or unauthorized access or use. In addition to the examples provided above, risk can be minimized by limiting the collection of data and deleting data once it is no longer needed. When applicable, data de-identification can be used to protect a user's privacy. De-identification may be facilitated, when appropriate, by removing identifiers, controlling the granularity or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, the exemplary DCAc does not require a specific location of the candidate computing nodes and/or the location granularity may be limited to a high level.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. One or more processors of a distributed computing management function (DCMF) configured to:
receive computing resource availability information from a first network node; and
transmit computing node information associated with the first network node to a second network node, wherein the second network node offloads one or more computing tasks to the first network node and the data for the one or more computing tasks does not traverse a core network.

2. The one or more processors of claim 1, further configured to:
receive, prior to transmitting the computing node information associated with the first network node to a second network node, a query for computing resource availability from the second network node.

3. The one or more processors of claim 2, wherein the query comprises at least one or more of a computing task ID, an application ID and a computing resource type.

4. The one or more processor of claim 2, wherein the query comprises information related to a computing task to be offloaded by the second network node including at least a data size to be processed.

5. The one or more processor of claim 2, wherein the query comprises constraints related to selecting a computing node for a computing task to be offloaded by the second network node, wherein the constrains include at least one of proximity, mobility, cost and energy efficiency.

6. The one or more processors of claim 2, further configured to:
match the first network node and the second network node in response to the query, wherein the matching comprises selecting the first network node from a centralized database.

7. The one or more processors of claim 6, wherein the selecting the first network node from the centralized database is based on trust level information associated with the first network node.

8. The one or more processors of claim 1, further configured to:
determine a user plane path between the first network node and the second network node, wherein the user plane path is utilized for offloading one or more computing tasks from the second network node to the first network node.

9. The one or more processors of claim 1, further configured to:
receive, prior to transmitting the computing node information associated with the first network node to a second network node, a subscription request from the second network node for computing node availability information.

10. The one or more processors of claim 9, wherein the DCMF periodically transmits the computing node availability information based on subscription information for the second network node.

11. The one or more processors of claim 1, further configured to:
receive matching node information from the second network node, wherein the second network node selects a computing node for offloading computing tasks based on the computing node availability information.

12. The one or more processors of claim 11, further configured to:
receive matching node information from the second network node, wherein the second network node selects a computing node for offloading computing tasks based on at least one of a trust level, a proximity, a cost and energy efficiency.

13. The one or more processors of claim 12, wherein the at least one of the trust level, the proximity, the cost and the energy efficiency is locally determined by the second node.

14. The one or more processors of claim 1, further configured to:
receive a registration request from the first network node;
authenticate the first network node in response to the request; and
transmit a temporary node identifier to the first network node based on a successful registration procedure.

15. The one or more processors of claim 14, wherein registration request comprises at least one or more of an application ID, a compute task ID, compute resource availability information and security information.

16. The one or more processors of claim 14, wherein the DCMF obtains parameters for authentication of the first network node from a network compute repository function (NCRF) or a network exposure function.

17. The one or more processors of claim 1, further configured to:
receive a registration request from the second network node;
authenticate the second network node in response to the request; and
transmit a temporary node identifier to the second network node based on a successful registration procedure.

18. The one or more processors of claim 17, wherein the DCMF obtains parameters for authentication of the first network node from a network compute repository function (NCRF) or a network exposure function.

19. A processor of a user equipment (UE) configured to:
transmit a request for computing resource availability to a distributed computing management function (DCMF); and
receive computing node information associated with a network node, wherein the UE offloads one or more computing tasks to the network node and the data for the one or more computing tasks does not traverse a core network.

20. One or more processors of a computing node configured to:
transmit computing resource availability information to a distributed computing management function (DCMF); and
establish a user plane with a user equipment (UE), wherein the UE offloads one or more computing tasks to the computing node and the data for the one or more computing tasks does not traverse a core network.
